(19) United States
(12) Patent Application Publication
(10) Pub. No.: US 2024/0009688 A1
(43) Pub. Date: Jan. 11, 2024

(54) SHOWER COMPONENTS

(71) Applicant: Kohler Co., Kohler, WI (US)

(72) Inventors: Gary Clarke, Sheboygan, WI (US); Tucker Jones, Elkhart Lake, WI (US); Connor McManus, Sheboygan, WI (US); Brandon Miller, Sheboygan, WI (US)

(73) Assignee: Kohler Co., Kohler, WI (US)

(21) Appl. No.: 18/319,600

(22) Filed: May 18, 2023

Related U.S. Application Data
(60) Provisional application No. 63/358,698, filed on Jul. 6, 2022.

(51) Int. Cl. B05B 1/18; E03C 1/04

(52) U.S. Cl. CPC B05B 1/185; E03C 1/0409

(57) ABSTRACT

The present disclosure is generally directed to adjustable components of a shower assembly. The shower assembly includes at least one showerhead moveably coupled to a shower rail by a joint. The joint is located at a position away from a center axis of the showerhead such that the showerhead can move between at least two independent showerhead positions. The shower rail includes at least one slidable component such that a position of the shower rail can be adjusted in at least one direction.

### CROSS-REFERENCE TO RELATED PATENT APPLICATIONS

This application claims the benefit of and priority to U.S. Provisional Patent Application No. 63/358,698, filed Jul. 6, 2022, which is incorporated herein by reference in its entirety.

### BACKGROUND

The present disclosure relates generally to shower assemblies (e.g., shower rail systems) that are intended for use in a showering environment. Such shower assemblies typically include a rail structure (or other similar type of structure) and one or more showerheads that are fluidly coupled thereto.

Various characteristics, such as a height of a user or an area of a shower wall, can constrain the use and functionality of the shower assembly. For example, users of different heights may desire showerheads at different heights (e.g., a first user may desire a showerhead positioned at a first position and a second user may desire a showerhead positioned at a different second position). As another example, some shower room areas may differ from others, such that one fixed shower rail may not be suitable for every shower room area (e.g., the location of the water inlet within one shower enclosure may differ from that in other locations, requiring a more involved installation and/or additional components to allow mounting of the shower assembly).

It would be advantageous to provide an improved shower assembly that addresses one or more of the aforementioned issues.

### SUMMARY

At least one aspect of the present disclosure relates to a shower assembly. The shower assembly includes at least one showerhead moveably coupled to a shower rail by a joint. The joint is located at a position away from a center axis of the showerhead such that the showerhead can move between at least two independent showerhead positions.

At least one aspect of the present disclosure relates to a showerhead. The showerhead includes a joint that can couple the showerhead to a shower environment. The joint is located at a position away from a center axis of the showerhead such that the showerhead can move between at least two independent showerhead positions relative to the shower environment.

At least one aspect of the present disclosure relates to a shower rail. The shower rail includes an inlet slidable between a first position and a second position along the shower rail. The shower rail includes an outlet that can couple to a showerhead by a joint. The joint can couple to the showerhead at a position away from a center axis of the showerhead.

At least one aspect of the present disclosure relates to a shower assembly. The shower assembly includes at least one showerhead coupled to a shower rail. The shower rail includes a slot that receives at least one inlet that couples to a shower area. The inlet can move relative to the shower rail. The inlet couples to a flexible conduit disposed within a portion of the shower rail such that the flexible conduit can move with the inlet. The flexible conduit slidably couples to a rigid conduit disposed within a portion of the shower rail such that movement of the inlet causes the flexible conduit to slide into or out of the rigid conduit to adjust a position of the inlet relative to the shower rail.

### BRIEF DESCRIPTION OF THE DRAWINGS

FIG. 1 is a front perspective view of a shower assembly, according to an exemplary embodiment.

FIG. 2 is a front perspective view of a shower assembly, according to an exemplary embodiment.

FIG. 3 is a side view of the shower assembly of FIG. 1, according to an exemplary embodiment.

FIG. 4 is a side view of the shower assembly of FIG. 2, according to an exemplary embodiment.

FIG. 5 is a schematic of a side view of a portion of the shower assembly of FIG. 2 moving between a first position and a second position, according to an exemplary embodiment.

FIG. 6 is a rear perspective view of a shower rail, according to an exemplary embodiment.

FIG. 7 is a rear view of the shower rail of FIG. 6 with a cover removed, according to an exemplary embodiment.

FIG. 8 is a rear perspective view of the shower rail of FIG. 6 with the cover removed, according to an exemplary embodiment.

FIG. 9 is a cross sectional view of a first side of the shower rail of FIG. 6, according to an exemplary embodiment.

FIG. 10 is a cross sectional view of a second side of the shower rail of FIG. 6, according to an exemplary embodiment.

FIG. 11 is a schematic representation of fluid flow within the shower rail of FIG. 6, according to an exemplary embodiment.

### DETAILED DESCRIPTION

Referring generally to the FIGURES, disclosed herein are adjustable shower components of a shower assembly. For example, the shower assembly can include an adjustable joint that allows movement of a showerhead between at least two positions. The shower assembly can additionally or alternatively include an adjustable shower rail that allows adjustment of a position of an inlet of the shower rail between at least two positions.

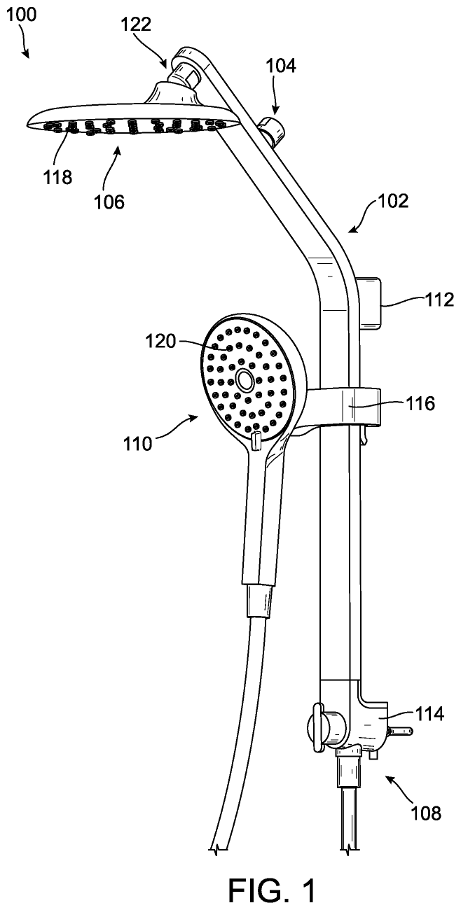

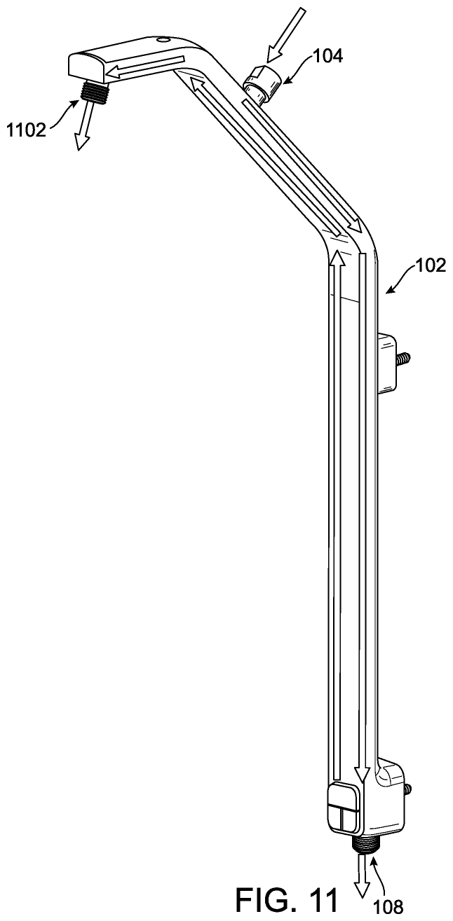

Referring to FIGS. 1-4, a shower assembly 100 is shown. The shower assembly 100 can include at least one shower rail 102 positioned in a shower environment. For example, the shower rail 102 can be or can include a bar, column, shower arm, conduit, or other structure that can facilitate receiving fluid and distributing fluid to at least one showerhead. For example, the shower rail 102 can include at least one hollow inner portion that houses one or more conduits (e.g., hoses, pipes, channels, etc.) that can allow fluid flow. In some embodiments, the shower rail 102 can include at least one hollow portion to receive fluid directly within the hollow portion. As described herein, the shower rail 102 can include at least one inlet (e.g., slidable inlet 104) that can receive a fluid, a first outlet (e.g., outlet 1102 shown in FIG. 11) fluidly coupled to the inlet 104 that can provide fluid received by the inlet 104 to a first showerhead, and a second outlet (e.g., outlet 108) fluidly coupled to the inlet 104 that can provide fluid received by the inlet 104 to a second showerhead. The shower rail 102 can include more or less inlets or outlets each coupled to more or less showerheads. While the rail 102 is depicted as rectangular in cross section in the figures, the rail 102 can include various other shapes including, but not limited to, round, triangular, or other shapes.

In some embodiments, the shower rail 102 can couple to a shower environment, such as a wall or ceiling. For example, the shower assembly 100 can include at least one inlet 104 capable of connecting with a fluid source (e.g., a water supply) to deliver fluid to the shower rail 102. In some embodiments, the inlet 104 can couple directly to a fluid source. In some embodiments, the inlet 104 can couple to a shower arm (e.g., a pipe, fitting, or other conduit that connects the inlet 104 to a fluid supply within a wall of a shower area). In some embodiments, the inlet 104 can couple to a portion of a shower area, such as a wall or ceiling. As described in greater detail herein, the inlet 104 can move relative to the shower rail 102 to adjust a position of the inlet 104 relative to the shower rail 102 to accommodate coupling to various shower areas and environments, such as coupling to a shower arm.

The shower assembly 100 can include at least one main showerhead 106. For example, the main showerhead 106 can be or can include a fixed showerhead (e.g., rain showerhead, massaging showerhead, a high-pressure showerhead, etc.) and/or other types of showerheads. The shower assembly 100 can include at least one second outlet 108 that delivers fluid within the shower rail 102 to a second showerhead 110. For example, the second showerhead 110 can be or can include a handheld showerhead or other types of showerheads that can couple to the rail 102. In some embodiments, the shower assembly 100 can include one or more conduits that can couple the second outlet 108 to the second showerhead 110 (e.g., within the hollow portion of the rail 102).

Each of the main showerhead 106 and the second showerhead 110 can include at least one outlet (e.g., nozzle) to expel fluid received from the inlet 104. For example, the main showerhead 106 can include one or more first nozzles 118 and the second showerhead 110 can include one or more second nozzles 120. In some embodiments, the first nozzles 118 and the second nozzles 120 can have similar configurations (e.g., same size and/or same shape). In some embodiments, the first nozzles 118 can differ from the second nozzles 120. In some embodiments, the shower assembly 100 can include the same amount of first nozzles 118 and second nozzles 120. In some embodiments, the amount of first nozzles 118 can be greater than or less than the amount of second nozzles 120.

The shower assembly 100 can include at least one component to facilitate coupling the shower rail 102 to a portion of a shower area, such as a wall, ceiling, or other surface. For example, the shower assembly 100 can include at least one first mount 112 and at least one second mount 114. The first mount 112 and/or the second mount 114 can be or can include one or more brackets, adhesives, spacers, fasteners, clamps, or other structures to facilitate coupling the shower rail 102 to a surface. In some embodiments, the first mount 112 and the second mount 114 can include brackets that are coupleable to the shower rail 102 by one or more fasteners.

In some embodiments, the first mount 112 and the second mount 114 can be the same (e.g., same size, structure, and/or same shape). In some embodiments, the first mount 112 can differ from the second mount 114. The first mount 112 and/or the second mount 114 can include one or more fasteners to facilitate coupling the shower rail 102 to a surface (e.g., a wall). The first mount 112 and/or the second mount 114 can include one or more adhesives (e.g., adhesive backings, tape, etc.) to facilitate coupling the shower rail 102 to a surface. In some embodiments, at least one of the first mount 112 or the second mount 114 can include or can position adjacent to a diverter described herein to facilitate switching fluid flow between the first nozzles 118 and the second nozzles 120.

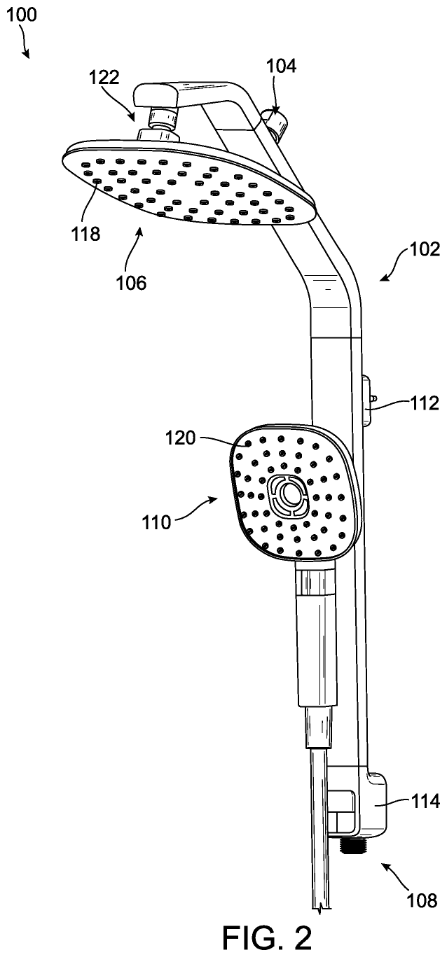

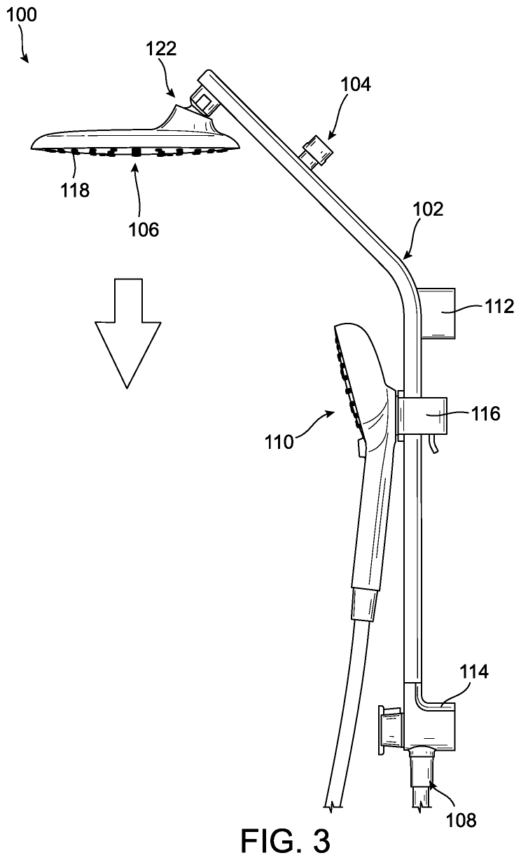

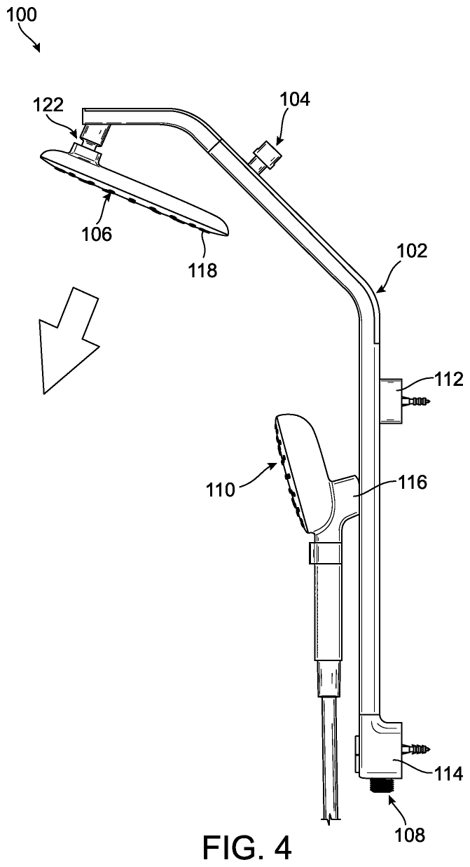

The shower assembly 100 can include at least one connection 116 to facilitate coupling the second showerhead 110 to the shower rail 102. For example, the connection 116 can be or can include one or more magnetic docking components (e.g., at least one magnet), clamps, sliding docks, mounts, receptacles, handles, and/or other structures that facilitate coupling the second showerhead 110 to the shower rail 102. For example, in the exemplary embodiment depicted in FIGS. 1 and 3, the connection 116 can include a sliding handle that releasably couples to the shower rail 102 by one or more clamps. As another example, in the exemplary embodiment depicted in FIGS. 2 and 4, the connection 116 can include a magnetic docking system (e.g., a magnet disposed within the shower rail 102 and/or a corresponding magnet disposed on a rear portion of the second showerhead 110). For example, as depicted in FIG. 4, the second showerhead 110 can magnetically couple directly to a portion of the rail 102.

The shower assembly 100 can include at least one adjustable component. For example, the inlet 104 of the shower assembly 100 can be adjusted relative to the shower rail 102 as described herein. As another example, the shower assembly 100 can include a joint 122 (e.g., a ball joint or other joints) that can couple the showerhead 106 (e.g., at outlet 1102 shown in FIG. 11) to the rail 102 to allow the main showerhead 106 to move (e.g., rotate, pivot, etc.) between one or more rotational positions relative to the rail 102.

The main showerhead 106 can couple to the shower rail 102 by the joint 122 at a location that is offset of a center point of the main showerhead 106. For example, the joint 122 can include or can be an off-center ball joint that is located at a position away from the center of the main showerhead 106 (e.g., towards one end of the main showerhead 106) such that rotation of the main showerhead 106 about the joint 122 moves the main showerhead 106 between at least two, distinct, and/or independently angled locations relative to the shower rail 102. The joint 122 can include various types of joints including, but not limited to a ball joint, hinge joint, a swivel joint, or various other types of joints.

FIG. 3 depicts the shower assembly 100 in a first rotational position in which the main showerhead 106 is positioned such that the first nozzles 118 of the main showerhead 106 are directed towards a first direction (e.g., substantially downward over a user when the shower assembly 100 is in use to act as a rain showerhead). FIG. 4 depicts the shower assembly 100 in a second rotational position that is different from the first rotational position. For example, in the second rotational position, the main showerhead 106 is rotated about 180 degrees about the joint 122 relative to the first rotational position such that the first nozzles 118 are directed towards a second direction that is at an angle relative to the first direction in the first rotational position (e.g., at an angle towards a user in use to act as a traditional showerhead).

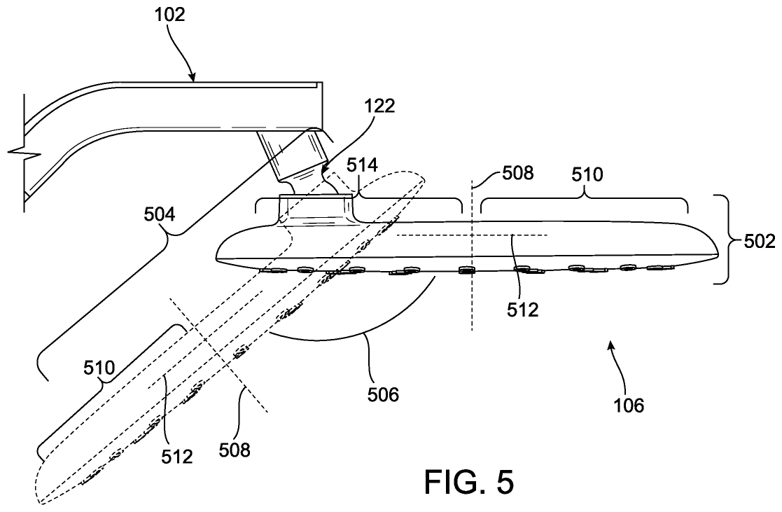

This rotation is depicted in FIG. 5, which illustrates one exemplary first rotational position (e.g., first position 502) of the main showerhead 106 and a potential second rotational position (e.g., second position 504, shown in dashed lines). As shown in FIG. 5, the joint 122 is positioned away from a center point of the main showerhead 106 (e.g., away from center axis 508) such that the main showerhead 106 rotates between the first and second position about a point that is positioned away from the center of the main showerhead 106.

With this configuration, the main showerhead 106 can rotate such that a first end 510 of the main showerhead 106 (e.g., about 50% of a length of the main showerhead 106 along axis 512 on a first side of the center axis 508) can be rotated 180 degrees about the joint 122 such that a difference between an initial position of the first end 510 and a final position of the first end 510 is greater than or equal to the length of the first end 510 about axis 512 (e.g., an axis that is perpendicular to the center axis 508). In other words, because the joint 122 is located at a position away from the center axis 508, the first end 510 of the main showerhead 106 is able to rotate about an axis spaced away from the center axis, which allows for a greater range and area of rotation than if the joint 122 were positioned at the center axis 508.

In some embodiments, the main showerhead 106 can rotate about the joint 122 such that the main showerhead 106 in the second position 504 is located at an angle 506 relative the main showerhead 106 in the first position 502. For example, the angle 506 can be in the range of 45 degrees to 180 degrees. The angle 506 can be lesser or greater than 45-180 degrees. For example, the angle 506 can be up to 360 degrees such that the showerhead 106 can make a full rotation. In this manner, the main showerhead 106 can be rotated about the joint 122 to define at least two independent, distinct main showerhead 106 positions. For example, in the first example position 502, the showerhead 106 can expel fluid in a substantially downward direction (e.g., in a direction substantially parallel to the center axis 508). In the second example position 504, the showerhead 106 can expel fluid at an angle 506 relative to a vertical plane (e.g., relative to the center axis 508 when the showerhead 106 is facing downward).

In some embodiments, the joint 122 is configured such that friction between a first portion of the joint 122 (e.g., a ball) and a second portion of the joint 122 (e.g., a socket portion of the main showerhead 106 that rotatably receives the ball) allows the main showerhead 106 to maintain in position during normal use conditions (e.g., when a user is not pushing or pulling on the main showerhead 106 to rotate the main showerhead 106). In other words, the main showerhead 106 remains in position after the main showerhead 106 is actuated between positions (e.g., by a user or hand tool exerting force upon the main showerhead 106 that is greater than the weight of the main showerhead 106 relative to the joint 122). In some embodiments, the joint 122, or another portion of the assembly 100 can include a locking component (e.g., a clamp, a fastener, etc.) to facilitate maintaining the main showerhead 106 in position after a user actuates the showerhead 106 to a new position.

It should be understood that the exemplary first and second rotational positions (e.g., rotations of 180 degrees) are shown and described for illustrative purposes. The main showerhead 106 can rotate in various directions or rotations to define a plurality of rotational positions. For example, the main showerhead 106 can rotate counterclockwise 90 degrees about the joint 122. The main showerhead 106 can rotate clockwise 45 degrees about the joint 122. The main showerhead 106 can rotate counterclockwise 360 degrees about the joint 122. In other words, the main showerhead 106 can rotate in either direction 360 degrees about the joint 122 to define a plurality of rotational positions.

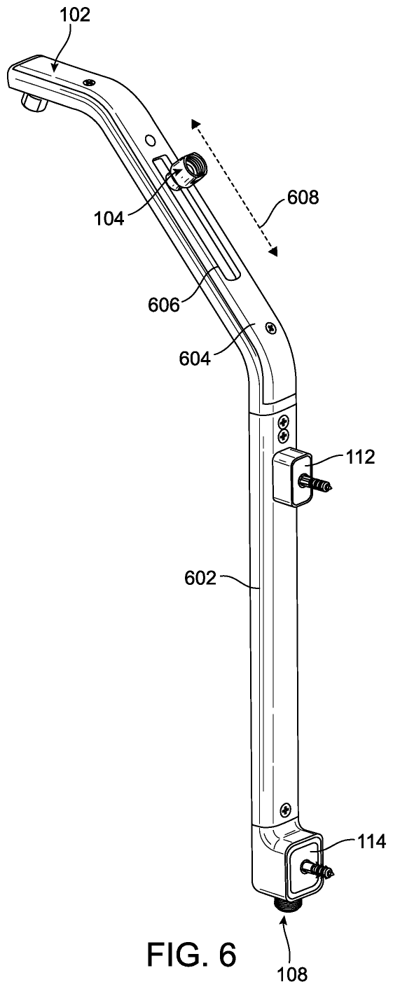

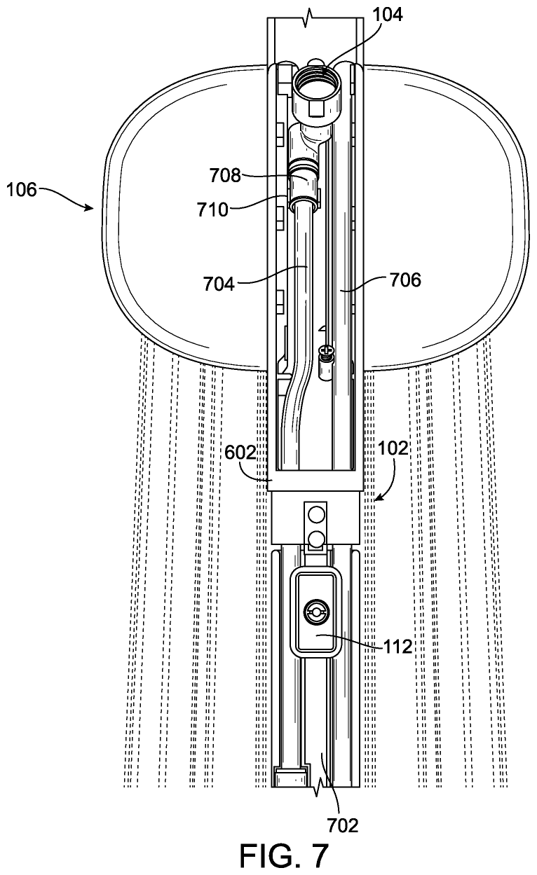

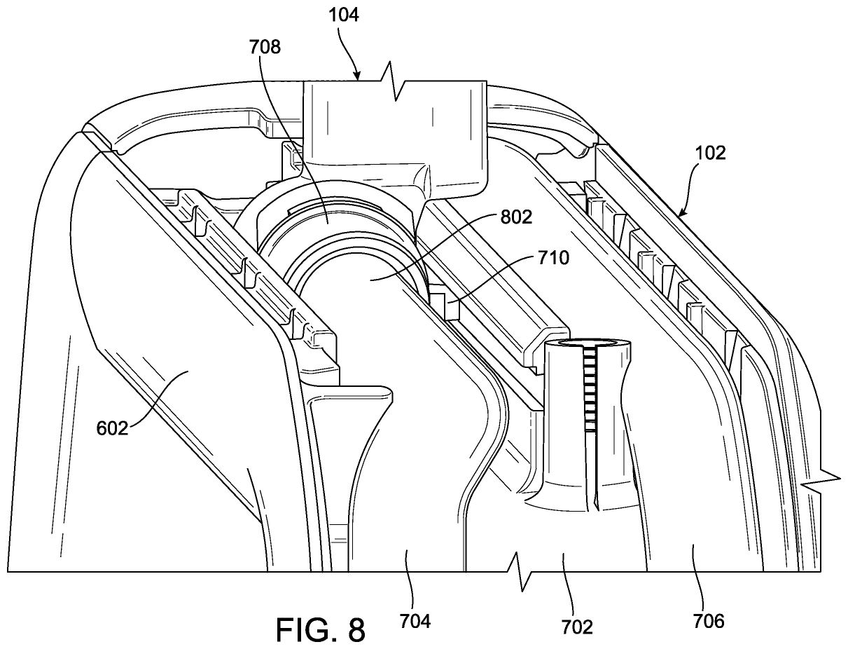

FIG. 6 depicts a rear perspective view of the shower rail 102. As described herein, the inlet 104 of the shower assembly 100 can be adjusted relative to the shower rail 102. For example, the inlet 104 can slidably/moveably couple to a portion of the shower rail 102 such that the inlet 104 can slide in at least one direction relative to the shower rail 102 between at least two positions along the shower rail 102. The shower rail 102 can include a housing 602 that defines and surrounds a hollow inner portion 702 (visible in at least FIGS. 7 and 8) of the shower rail 102. The housing 602 can include at least one cover 604 that can removably couple to a portion of the housing 602 to cover or uncover the inner hollow portion 702. For example, FIGS. 7 and 8 depict the shower rail 102 with the cover 604 removed from the housing 602 for illustrative purposes. The cover 604 can removably couple to the housing 602 in a variety of ways including, but not limited to, fasteners, adhesives, welding, or other techniques. In some embodiments, the housing 602 may be monolithic with the cover.

The shower rail 102 can include at least one slot 606 that receives the inlet 104. For example, the slot 606 can be located on the cover 604 of the shower rail 102. The inlet 104 can slide relative to the slot 606 such that the shower rail 102 is movable relative to the shower area to which the inlet 104 is coupled (e.g., the shower rail 102 can slide relative to inlet 104 in direction of the arrow 608 the length of the slot to adapt to different shower spaces). For example, the inlet 104 can slide in the direction of the arrow 608 between at least two positions (and/or more than two positions) such that the inlet 104 can couple to a shower arm positioned at various heights relative to the first mount 112 and/or the second mount 114 (e.g., the location of a connection between the inlet 104 and a water supply can be adjusted relative to a location of the first mount 112 and/or the second mount 114).

In some embodiments, the slot 606 is substantially oblong or rectangular in shape with a width (e.g., a dimension perpendicular to the arrow 608) that is about equal to or slightly greater than a corresponding width of the inlet 104 such that the inlet 104 can freely slide in at least one direction relative to the slot 606. The width of the slot 606 can be less than the inlet 104 in at least one direction such that the inlet 104 can remain positioned within the hollow portion 702 of the rail 102.

The hollow inner portion 702 can receive at least one conduit that fluidly couples to the inlet 104, the first nozzles 118, and/or the second nozzles 120. For example, the hollow inner portion 702 can receive a first conduit 704 and a second conduit 706. In some embodiments, the first conduit 704 can position adjacent to the second conduit 706. The inlet 104 can fluidly couple to the first conduit 704 disposed within the hollow inner portion 702 of the shower rail 102 such that the first conduit 704 can slide relative to the shower rail 102 when the inlet 104 moves.

The first conduit 704 can be or can include at least one flexible conduit. For example, the first conduit 704 can include a plurality of conduits that are fluidly coupled to one another. A first portion of the first conduit 704 can be made of flexible material such that the first conduit 704 can follow a bend of the shower rail 102 positioned at or near the main showerhead 106. As described herein, the first conduit 704 can include at least one rigid conduit positioned near the second outlet 108. As shown in FIGS. 7 and 8, the first conduit 704 can couple to the inlet 104 by a fitting 708 (e.g., a female fitting) that receives a coupling portion 802 (e.g., a male portion) coupled to the first conduit 704 by welding, fasteners, adhesives, or other techniques. The coupling portion 802 can be monolithically formed with the first conduit 704, or the coupling portion 802 can be formed independently and connected to the first conduit 704 via one or more bonds, adhesives, clamps, or fasteners.

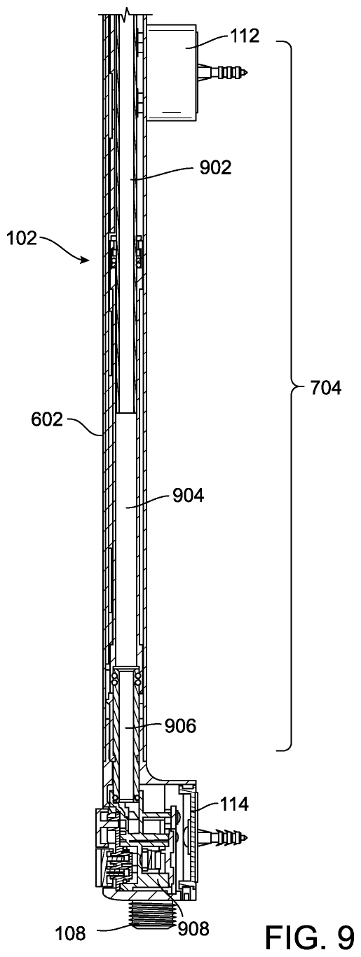

The inlet 104 and the first conduit 704 can couple to the fitting 708 and can be secured in place by a clip 710 (e.g., a C-clip). The first conduit 704 can be welded to the fitting 708, or attached in various other ways (e.g., adhesives, clamps, etc.). Accordingly, the first conduit 704 can be fixed to the inlet 104 such that the first conduit 704 moves when the inlet 104 moves. For example, as the inlet 104 moves in the direction of the arrow 608 shown in FIG. 6, the inlet 104 causes the first conduit 704 to move (e.g., slide) relative the housing 602 of the shower rail 102. A flexible portion 902 (e.g., the flexible conduit) of the first conduit 704 (visible in at least FIG. 9, which depicts a cross sectional view of a portion of the shower rail 102) can slide into a hollow inner portion of a rigid portion 904 (e.g., a rigid conduit) of the first conduit 704 to provide a telescoping adjustment. It should be understood that the first conduit 704 can include one or more (e.g., at least two) conduits that fluidly couple to one another. In this manner, the flexible portion 902 of the first conduit can slide within a hollow portion of the fixed rigid portion 904 of the first conduit 704 such that the flexible portion 902 slides relative to the rigid portion 904.

The rigid portion 904 can be secured by an insert 906 (e.g., a rigid plastic insert), which can compress a fitting of a diverter 908 that diverts fluid between the first conduit 704 (e.g., the combination of the flexible conduit and the rigid conduit), the second conduit 706 (e.g., the conduits positioned adjacent the first conduit 704 in the shower rail 102), and a second outlet 108 that provides fluid to the second showerhead 110. As depicted in FIG. 9, the diverter 908 can be positioned at a bottom end of the rail 102 (e.g., at or near the second outlet 108 that provides fluid to the second showerhead 110).

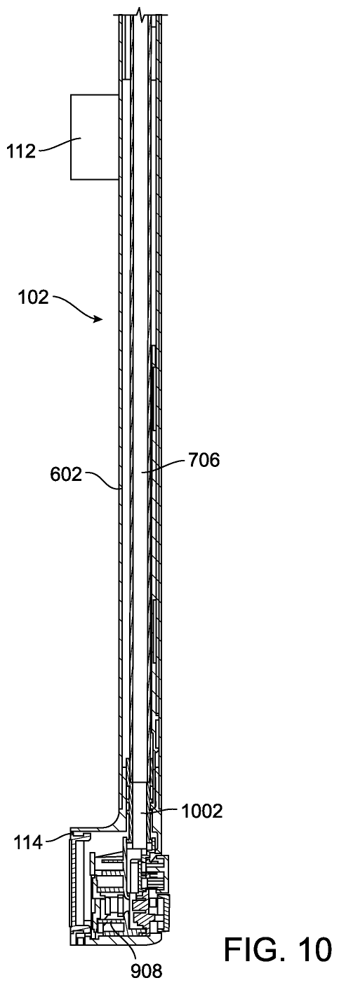

FIG. 10 depicts a cross sectional view of the portion of the shower rail 102 shown in FIG. 9 from an opposing side of FIG. 9 (e.g., on the side having the second conduit 706). As shown in FIG. 10, the diverter 908 can fluidly couple to the second conduit 706 by a second fitting 1002 (e.g., a female fitting) that receives a coupling portion (e.g., a male portion) coupled to the second conduit 706. The second conduit 706 can extend throughout the housing 602 of the shower rail 102 to provide fluid to the first nozzles 118 of the main showerhead 106.

FIG. 11 depicts a schematic representation of fluid flow within the shower rail 102. As shown by the arrows in FIG. 11, fluid can enter the inlet 104 (e.g., via a municipal water supply) and flow down through the first conduit 704 (e.g., conduits positioned on the right-hand side of the inside of the shower rail 102 in FIG. 11). Fluid can flow down through the first conduit 704 to the diverter 908, where fluid can be diverted to the second conduit 706 to discharge out of the main showerhead 106 (e.g., out of outlet 1102 which can fluidly couple to the main showerhead 106) and/or to the second outlet 108 which can fluidly couple to the second showerhead 110 to discharge from the second nozzles 120 of the second showerhead 110.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the showerheads as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element (e.g., rail, main showerhead, handheld showerhead, etc.) disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A shower assembly, comprising:
a showerhead configured to moveably couple to a shower rail by a joint; and
wherein the joint is located at a position away from a center axis of the showerhead such that the showerhead can move between at least two independent showerhead positions relative to the shower rail.

2. The shower assembly of claim 1, wherein the shower rail includes:
a hollow portion having at least one conduit; and
a removable cover configured to at least partially cover the at least one conduit.

3. The shower assembly of claim 1, further comprising:
an inlet fluidly coupled to the showerhead and configured to receive a fluid; and
wherein the inlet is configured to slidably couple to the shower rail.

4. The shower assembly of claim 1, wherein the joint is configured to maintain the showerhead in position after the showerhead is actuated to one of the at least two independent showerhead positions.

5. The shower assembly of claim 1, further comprising a second showerhead configured to removably couple to the shower rail by at least one of a clamp or a magnet.

6. The shower assembly of claim 1, wherein a difference in angle between a first position of the at least two independent showerhead positions and a second position of the at least two independent showerhead positions is in the range of 45 degrees to 180 degrees.

7. The shower assembly of claim 1, wherein the showerhead comprises at least one of a rain showerhead or a massaging showerhead.

8. The shower assembly of claim 1, wherein the joint comprises a ball joint.

9. The shower assembly of claim 1, wherein:
the showerhead is configured to spray fluid in a downward direction in a first position of the at least two independent showerhead positions; and
the showerhead is configured to spray fluid at an angle relative to a vertical plane in a second position of the at least two independent showerhead positions.

10. A showerhead, comprising:
a joint configured to couple the showerhead to a shower environment; and
wherein the joint is located at a position away from a center axis of the showerhead such that the showerhead can move between at least two independent showerhead positions relative to the shower environment.

11. The showerhead of claim 10, wherein the shower environment includes at least one of a shower rail or a shower arm.

12. The showerhead of claim 10, wherein the joint is configured to maintain the showerhead in position after the showerhead is actuated to one of the at least two independent showerhead positions.

13. The showerhead of claim 10, wherein a difference in angle between a first position of the at least two independent showerhead positions and a second position of the at least two independent showerhead positions is in the range of 45 degrees to 180 degrees.

14. The showerhead of claim 10, wherein the showerhead comprises at least one of a rain showerhead or a massaging showerhead.

15. The showerhead of claim 10, wherein the joint comprises a ball joint.

16. A shower rail, comprising:
an inlet slidable between a first position and a second position along the shower rail; and
an outlet configured to couple to a showerhead by a joint;
wherein the joint is configured to couple to the showerhead at a position away from a center axis of the showerhead.

17. The shower rail of claim 16, further comprising:
a hollow portion having at least one conduit fluidly coupled to the inlet; and
a removable cover configured to at least partially cover the at least one conduit.

18. The shower rail of claim 16, wherein the shower rail is configured to couple to a handheld showerhead by one of a magnet or a clamp.

19. The shower rail of claim 16, further comprising:
a second outlet; and
a diverter;
wherein the diverter is configured to control fluid flow between the inlet, the outlet, and the second outlet.

20. The shower rail of claim 16, wherein the joint comprises a ball joint.
